(19) United States
(12) Patent Application Publication
(10) Pub. No.: US 2026/0004520 A1
(43) Pub. Date: Jan. 1, 2026

(54) METHOD AND TERMINAL FOR CONTINUOUS EXPRESSION-TRANSFORMATION OF PAN-MAPS BASED ON CONTINUITY FEATURES

(71) Applicant: SHENZHEN UNIVERSITY, Shenzhen (CN)

(72) Inventors: Yebin CHEN, Shenzhen (CN); Renzhong GUO, Shenzhen (CN); Zhigang ZHAO, Shenzhen (CN); Ding MA, Shenzhen (CN); Wei ZHU, Shenzhen (CN); Yaxing LI, Shenzhen (CN)

(73) Assignee: SHENZHEN UNIVERSITY, Shenzhen (CN)

(21) Appl. No.: 19/062,116

(22) Filed: Feb. 25, 2025

(30) Foreign Application Priority Data
Jun. 26, 2024 (CN) 202410832606.5

(51) Int. Cl. G06T 17/05; G06T 7/73; G06T 15/04; G06V 10/52; G06V 10/764; G06V 10/77

(52) U.S. Cl. CPC G06T 17/05; G06T 7/74; G06T 15/04; G06V 10/52; G06V 10/765; G06V 10/7715; G06T 2207/30181; G06T 2210/61

(57) ABSTRACT

A method and a terminal for continuous expression-transformation of pan-maps based on continuity features, and the method includes: obtaining pan-map type cases, classifying and categorizing the pan-map type cases to obtain a plurality of map types, and constructing a pan-map classification system; extracting continuous transformation association information between the plurality of map types according to the pan-map classification system, and constructing continuous transformation rules of the pan-map; performing, based on the continuous transformation rules of the pan-map, continuous expression-transformation processing on a plurality of pan-map types, and outputting continuous expression-transformation results of the plurality of pan-map types. The method can enhance the information richness and continuity of the map, and improve efficiency of information association, integration and transmission.

### CROSS-REFERENCE TO RELATED APPLICATIONS

The present disclosure claims priority to Chinese Patent Application No. 202410832606.5, filed on Jun. 26, 2024, the content of all of which is incorporated herein by reference.

### FIELD

The present disclosure relates to the technical field of visualization, in particular to a method and a terminal for continuous expression-transformation of pan-maps based on continuity features.

### BACKGROUND

Due to constraints of the carrier medium, most traditional maps can only express spatial distribution and spatial relationship of geographic spatial objects and phenomena in a discrete way, which can only convey relatively limited information. In the Information and communication technology (ICT) era, maps have shown a significant generalization trend, and a variety of maps and map-like forms have emerged, collectively referred to as pan-maps. Compared with traditional maps, pan-maps can express richer information, including geographic spatial information, topological information, relationship information, and statistical information.

However, due to a lack of correlation between different pan-maps, the information expression lacks continuity, which easily affects user's cognition of change process of spatial objects. Existing pan-maps are difficult to achieve continuous transformation between maps, and cannot dynamically and intuitively display spatial object information from multiple angles, multiple levels, and all directions. It is difficult to meet the needs of associating, integrating, and transmitting multiple information in the ICT era.

Therefore, the prior art needs to be improved.

### SUMMARY

In view of the above-mentioned deficiencies in the prior art, an object of the present disclosure is to provide a method and a terminal for continuous expression-transformation of pan-maps based on continuity features, aiming to solve the problem of difficulty in the existing pan-maps to achieve continuous transformation between maps.

The technical solutions adopted by the present disclosure to solve the technical problem is as follows:

In a first aspect, the present disclosure provides a method for continuous expression-transformation of pan-maps based on continuity features, including:
obtaining pan-map type cases, classifying and categorizing the pan-map type cases to obtain a plurality of map types, and constructing a pan-map classification system;
extracting continuous transformation association information between the plurality of map types according to the pan-map classification system, and constructing continuous transformation rules of the pan-map;
performing, based on the continuous transformation rules of the pan-map, continuous expression-transformation processing on a plurality of pan-map types, and outputting continuous expression-transformation results of the plurality of pan-map types.

In one embodiment, the step of obtaining pan-map type cases, classifying and categorizing the pan-map type cases to obtain a plurality of map types, and constructing a pan-map classification system includes:
obtaining a plurality of map type cases, and classify the plurality of map type cases from perspectives of point maps, line maps, surface maps, and volume maps to obtain the plurality of map types;
constructing the pan-map classification system based on classification results.

In one embodiment, the step of constructing the pan-map classification system based on classification results, includes:
displaying, based on the classification results of the map types, the map types of different levels and subcategories by a tree structure to form the pan-map classification system;
placing, on a basis of the pan-map classification system, the each pan-map type case in a database of the corresponding type, and constructing a pan-map case library.

In one embodiment, the continuous transformation rules of the pan-map includes: one or a combination of regularization, exaggeration, dimension transforming, element aggregation, element divergence, metaphor, dynamicization, tagging, curling, multi-scale, stylization, texturing, and geometric simplification;
where the step of extracting continuous transformation association information between the plurality of map types according to the pan-map classification system, and constructing continuous transformation rules of the pan-map includes:
extracting, based on the pan-map classification system, continuity association information of elements between the plurality of map types by an inductive method;
summarizing and generalizing mechanism and logic of the continuity association information of the elements between the plurality of map types to construct the continuous transformation rules of the pan-map.

In one embodiment, the regularization in the continuous transformation rules of the pan-map comprises: one or a combination of structural relationship mapping, geometric substituting, and geometric regular filling;
the step of constructing continuous transformation rules of the pan-map includes:
transforming positions of spatial objects and keeping topological relationships of the spatial objects unchanged to achieve the structural relationship mapping;
replacing irregular graphics with regular symbol units to achieve the geometric substituting;
filling the irregular graphics with the regular symbol units to obtain gridded maps, rasterized maps, and textured maps, thereby realizing the geometric regular filling.

In one embodiment, the exaggeration in the continuous transformation rules of the pan-map includes: geometric reconstructing and position resetting;
the step of constructing continuous transformation rules of the pan-map further includes:
highlighting key units to achieve the geometric reconstructing;
resetting positions of spatial objects by explicitly expressing important icons to achieve the position resetting.

In one embodiment, the dimension transforming in the continuous transformation rules of the pan-map includes: object dimension reducing and object dimension increasing;
the step of constructing continuous transformation rules of the pan-map further includes:
simplifying, by geometric dimension reducing and position remapping, high-dimensional space objects into low-dimensional space expressions to achieve the object dimension reducing;
increasing, by geometric dimension increasing and the position remapping, low-dimensional spatial information to higher-dimensional expressions to achieve the object dimension increasing.

In one embodiment, the step of performing, based on the continuous transformation rules of the pan-map, continuous expression-transformation processing on a plurality of pan-map types, and outputting continuous expression-transformation results of the plurality of pan-map types, includes:
performing, based on the continuous transformation rules of the pan-map, the continuous expression-transformation processing on the plurality of pan-map types by a progressive transformation algorithm;
outputting the continuous expression-transformation results of the plurality of pan-map types.

In a second aspect, the present disclosure further provides a terminal, including a processor and a memory, where the memory stores a program for continuous expression-transformation of pan-maps based on continuity features, and where the program for continuous expression-transformation of pan-maps based on continuity features is executed by the processor, the program is used to implement the method for continuous expression-transformation of pan-maps based on continuity features.

In a third aspect, the present disclosure further provides a computer-readable storage medium, where the computer-readable storage medium stores a program for continuous expression-transformation of pan-maps based on continuity features, and when the program for continuous expression-transformation of pan-maps based on continuity features is executed by a processor, the program is used to implement the method for continuous expression-transformation of pan-maps based on continuity features.

Compared with the prior art, the embodiments of the present disclosure have the following advantages:

According to the present disclosure, a plurality of map types can be obtained by obtaining pan-map type cases, and classifying and categorizing the pan-map type cases, thus a pan-map classification system can be constructed; continuous transformation association information between the plurality of map types can be extracted according to the pan-map classification system, and constructing continuous transformation rules of the pan-map can be constructed; based on the continuous transformation rules of the pan-map, continuous expression-transformation of the plurality of pan-map types can be realized, thus improving the information carrying capacity of maps and providing support for the association, integration and transmission of multiple information in the ICT era. The present disclosure provides a method for continuous expression-transformation of pan-maps based on continuity features, which enhances the information richness and continuity of the map and improves the efficiency of information association, integration and transmission.

### BRIEF DESCRIPTION OF THE DRAWINGS

In order to more clearly illustrate the embodiments of the present disclosure or the technical solutions in the prior art, the drawings required for use in the embodiments or the description of the prior art are briefly introduced below. Obviously, the drawings described below are only some embodiments of the present disclosure. For those skilled in the art, other drawings can be obtained based on these drawings without involving innovative work.

FIG. 1 is a flow chart of a method for continuous expression-transformation of pan-maps based on continuity features in one embodiment of the present disclosure.

FIG. 2 is a flow chart of a step of continuous transformation of a map in one embodiment of the present disclosure.

FIG. 3 is a schematic diagram of a pan-map classification system in one embodiment of the present disclosure.

FIG. 4 is an association diagram of continuous transformation rules of a pan-map in one embodiment of the present disclosure.

FIG. 5 is a functional schematic diagram of a terminal in one embodiment of the present disclosure.

The realization of the purpose, functional features, and advantages of the present disclosure are further explained in conjunction with embodiments and with reference to the accompanying drawings.

### DETAILED DESCRIPTION OF EMBODIMENTS

The present disclosure provides a method and a terminal for continuous expression-transformation of pan-maps based on continuity features. In order to make the purpose, technical solutions and advantages of the present disclosure clearer and more specific, the present disclosure is further described in detail with reference to the accompanying drawings and examples. It should be understood that the specific embodiments described herein are only used to explain the present disclosure and are not intended to limit the present disclosure.

### A Method Embodiment

In the prior art, traditional maps mainly rely on static and discrete methods to display geographic information, which limits comprehensive transmission of information. Although the emergence of pan-maps has expanded the diversity of information, including the expression of geographic, topological, relational and statistical information, the lack of continuous association between pan-maps has affected users' understanding of the spatial change process.

In response to the above technical problems, an embodiment of the present disclosure provides a method for continuous expression-transformation of pan-maps based on continuity features, with the aim of proposing a new method for continuous expression-transformation of a pan-map, enhancing the information richness and continuity of the map, and improving the efficiency of information association, integration and transmission.

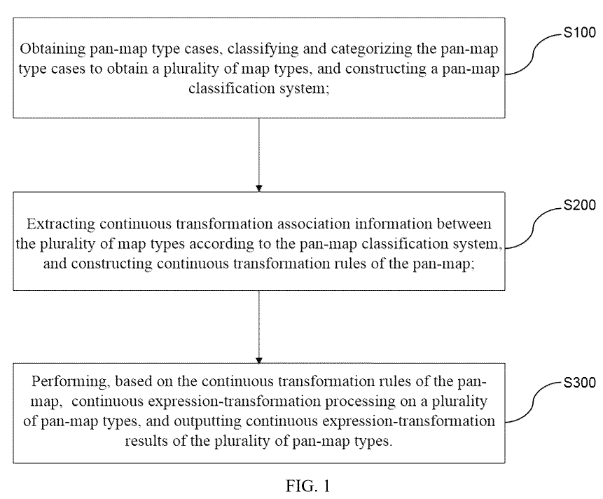

As shown in FIG. 1, an embodiment of the present disclosure provides a method for continuous expression-transformation of pan-maps based on continuity features includes the following steps:
Step S100, obtaining pan-map type cases, classifying and categorizing the pan-map type cases to obtain a plurality of map types, and constructing a pan-map classification system.

In the embodiment, the method for continuous expression-transformation of pan-maps based on continuity features is applied to a terminal, and the terminal includes but is not limited to: a computer, a mobile terminal, and other devices; the terminal is provided with a training migration platform for a pan-map continuous expression model.

In the embodiment, due to a generalized expression of the map, the map presents trends such as regularization, virtualization, and metaphor. In view of the continuous transformation features presented by the pan-map, a pan-map continuous expression model is provided. The pan-map continuous expression model abstractly summarizes basic principles followed by the continuous transformation of the pan-map, and based on the model, a method for continuous expression-transformation is proposed, 13 transformation rules for map continuous transformation are summarized, and based on the transformation rules, the continuous transformation of various maps is realized, and a method for map-to-map continuous transformation is obtained.

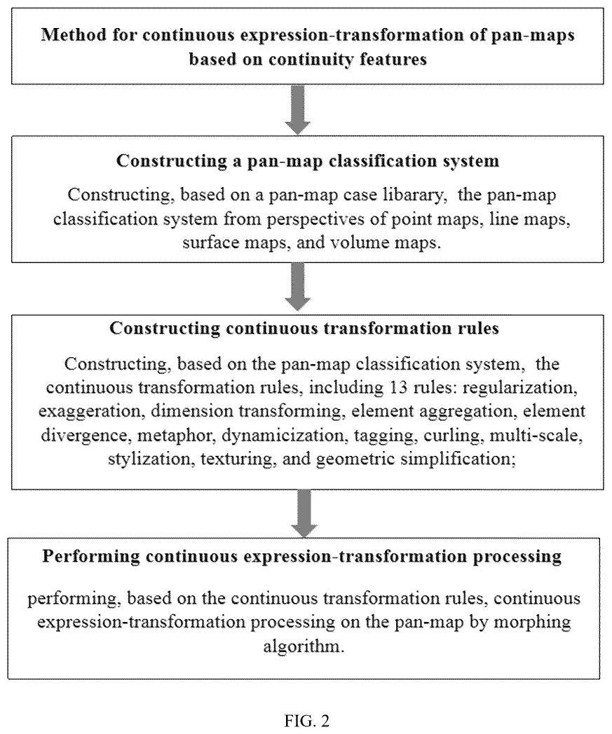

As shown in FIG. 2, in the embodiment, first, map cases are collected and the pan-map classification system is constructed; second, based on the constructed pan-map classification system, the transformation rules between maps are extracted; finally, based on the continuous transformation rules of the pan-map, the continuous expression of pan-map types such as point maps, line maps, surface maps, and volume maps is realized through map morphing progressive transformation. Based on the continuity features between pan-maps, the embodiment proposes the method for continuous expression-transformation of pan-maps based on continuity features, helping to realize the association, integration, and transmission of multi-dimensional information.

Further, in an implementation of the embodiment, the step S100 includes the following steps:
Step S110, obtaining a plurality of map type cases, and classify the plurality of map type cases from perspectives of point maps, line maps, surface maps, and volume maps to obtain the plurality of map types;
Step S120, constructing the pan-map classification system based on classification results.

In the embodiment, map type cases can be retrieved and obtained from multiple source channels such as the Internet, atlas, domestic and foreign literature, including: traditional maps such as administrative division maps, contour maps, shading maps, point distribution maps, as well as Cartogram maps (deformed maps), schematic subway maps, Kriskograms maps, Whisper maps and other types of maps.

In the embodiment, based on the collected map cases, maps are classified according to the expression forms and features. The classification perspectives include point maps, line maps, surface maps, volume maps, etc. The classification method covers the basic morphological differences of maps when expressing geographic spatial information. By summarizing the common features and differences of the cases, the systematic pan-map classification system is constructed. The classification system not only reflects the morphological diversity of maps, but also provides a framework for the subsequent extraction of continuous transformation rules.

In the embodiment, the pan-map classification system is constructed based on the above classification, forming a hierarchical classification structure to clearly distinguish different map types. By constructing the pan-map classification system, it is helpful to clarify the relationship between different map types and the potential connection in continuous transformation, laying a solid foundation for the formulation and application of continuous transformation rules.

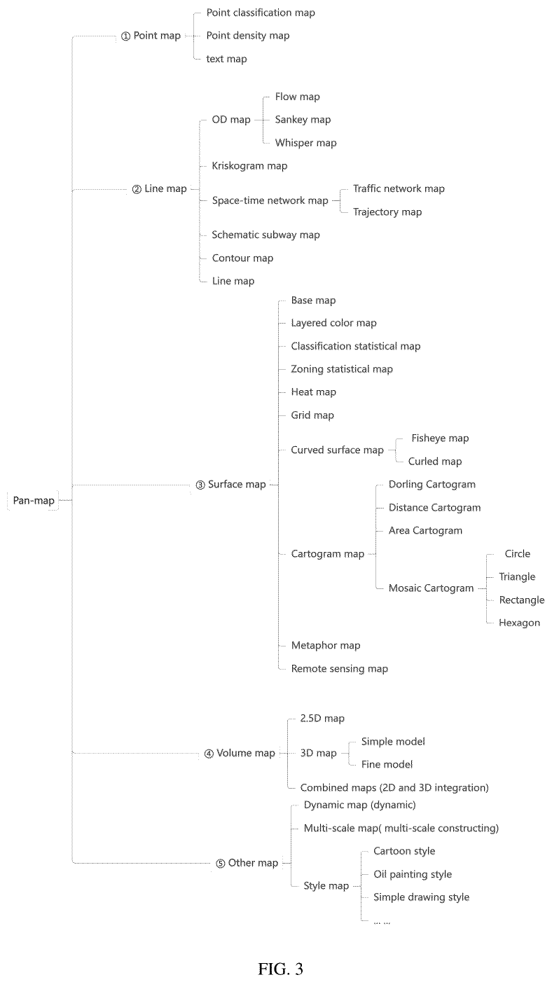

As shown in FIG. 3, the embodiment, through case acquisition, classification and system construction, ultimately forms the pan-map classification system covering various map types, promotes the continuity of information expression, and thus improves the efficiency of map information transmission and the user's cognitive experience.

Further, in an implementation of the embodiment, the step S120 includes the following steps:
Step S121, displaying, based on the classification results of the map types, the map types of different levels and subcategories by a tree structure to form the pan-map classification system;
Step S122, placing, on a basis of the pan-map classification system, the each pan-map type case in a database of the corresponding type, and constructing a pan-map case library.

In the embodiment, based on the classification results of map types, a clearly hierarchical pan-map classification system is constructed, which displays map types of different levels and subcategories in a tree structure to ensure the systematicness and comprehensibility of the classification.

In the embodiment, the map types of the universal map are divided into: point maps, line maps, surface maps, volume maps, and other maps.

Further, the point maps include point classification maps, point density maps and text maps, etc. The line maps include OD maps (Origin-Destination maps, starting point-end point connection maps), the Kriskogram maps, space-time network maps, schematic subway maps, contour maps, line drawing maps, etc. The surface maps include base maps, layered color maps, classification statistical maps, zoning statistical maps, heat maps, grid maps, curved surface maps, cartogram maps, metaphor maps, remote sensing maps, etc. The volume maps include: 2.5D maps, 3D maps, combined maps (2D and 3D integration), etc. The other maps include: dynamic maps (dynamicization), multi-scale maps (multi-scale construction), style maps, etc.

Further, the OD maps include: flow maps, Sankey maps, Whisper maps, etc.; the space-time network maps include traffic network maps and trajectory maps, etc.; the curved surface maps include fisheye maps and curled maps, etc. The Cartogram maps include Dorling Cartogram, Distance Cartogram, Area Cartogram, Mosaic Cartogram, etc. The Mosaic Cartogram includes circle, triangle, rectangle and hexagon, etc. The 3D maps include simple model and fine model. The style maps include cartoon style, oil painting style, simple drawing style, etc.

In the embodiment, after constructing the pan-map classification system, a large number of collected map cases are classified one by one into the corresponding sub-type database according to the above classification system, and a pan-map case library is constructed to ensure that each map case has a corresponding precise position in the classification system, ensuring the orderliness and retrieval convenience of the case library.

As shown in FIG. 1, in an implementation of the embodiment of the present disclosure, the method for continuous expression-transformation of pan-maps based on continuity features further includes the following steps:
Step S200: extracting continuous transformation association information between the plurality of map types according to the pan-map classification system, and constructing continuous transformation rules of the pan-map.

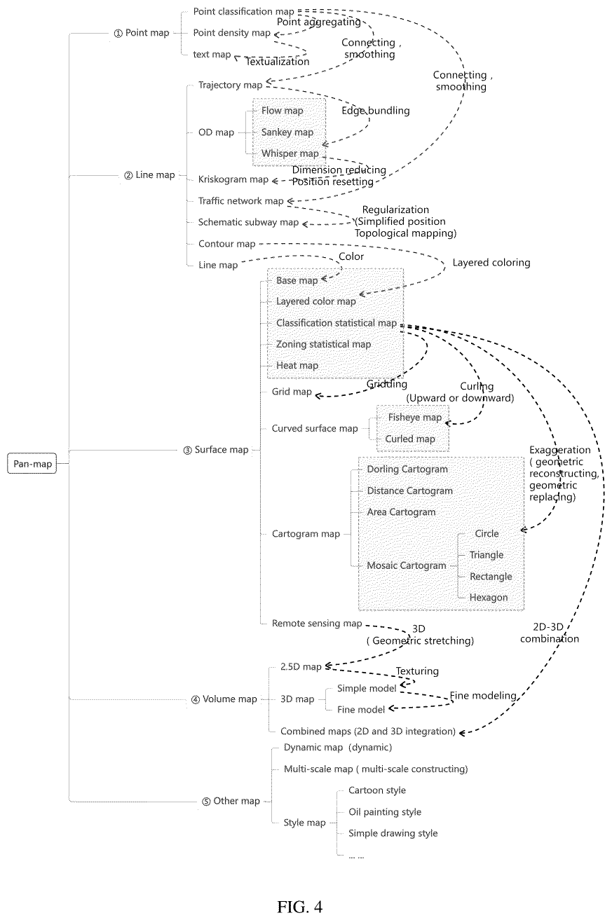

In the embodiment, as shown in FIG. 4, based on the pan-map classification system, the continuity association between elements of the map-to-map is extracted by generalization and summarization, such as the trajectory map can be obtained by connecting a starting point and an end point with a migration relationship in a fixed-point symbol map, and smoothing a connection line. Then a mechanism of action of the connections and the logic behind them are summarized and sorted out, such as the point aggregation from the point density map to the point classification map, and the edge bundling from the trajectory map to the OD map, and finally the 13 rules of map continuous transformation including regularization, exaggeration, dimension transforming, element aggregation, element divergence, metaphor, dynamicization, tagging, curling, multi-scale, stylization, texturing, and geometric simplification are obtained. The transformation rules are not either this or that, and the transformation rules are conceptually distinct, but can be interrelated and interoperable and can be used in combination to form a continuous transformation. For example, the point map is transformed into the point classification map through the aggregation and position adjustment of the points; the line map is smoothed and connected to form the trajectory map; the surface map is aggregated and simplified to achieve the continuous transformation to the point map.

In the embodiment, the continuous transformation rules of the pan-map not only improve the richness and continuity of map information expression, but also meet the needs of the ICT era for associating, integrating, and transmitting multiple information. Through the continuous transformation rules, the pan-map dynamically and intuitively displays the geographic, topological, relational, statistical and other information of spatial objects, enhancing the user's cognitive understanding of the spatial change process.

Further, in an implementation of the embodiment, step S200 includes the following steps:
Step S210, extracting, based on the pan-map classification system, continuity association information of elements between the plurality of map types by an inductive method;
Step S220, summarizing and generalizing mechanism and logic of the continuity association information of the elements between the plurality of map types to construct the continuous transformation rules of the pan-map.

In the embodiment, the inductive method is used, starting from the constructed pan-map classification system, by analyzing the visual similarities and continuity of information expression between different map cases, to find the similarities and connections in visual expression, information display logic, spatial relationship and data abstraction degree. For example, the aggregation of points between point maps and line maps can form a trajectory, which produces continuity; the aggregation of surface maps is associated with the density change of points in the point maps, showing a continuous transition from details to overview; for example, the conversion of trajectory maps to OD maps can clearly show the relationship between the starting point and the end point through the connection and bundling of edges.

In the embodiment, based on the above analysis, a series of continuous transformation rules can be summarized, and the continuous transformation rules of the pan-map include: regularization, exaggeration, dimension transforming, element aggregation, element divergence, metaphor, dynamicization, tagging, curling, multi-scale, stylization, texturing, and geometric simplification. The rules not only involve the geometric changes of map elements, but also include one or a combination of the conversion of information expression methods.

Further, the continuous transformation rules of the pan-map are shown in Table 1:

TABLE 1

| Sort | Expression rules | Expression methods | Description |
|---|---|---|---|
| Regularization | Structural | Regularization of | An arbitrary positional |
| | relationship | topological | transformation of |
| | mapping | relationship | spatial objects, such as |
| | | | changing curvature or |
| | | | direction of lines, but in |
| | | | the process, ensure that |
| | | | the relative positional |
| | | | relationship and |
| | | | connectivity between |
| | | | objects remain |
| | | | unchanged |
| | Geometric | Geometric unit | Using standard |
| | substituting | assimilation | geometric units (such |
| | | processing | as triangles, squares, |
| | | | rectangles, hexagons, |
| | | | circles, etc.) to replace |
| | | | the original complex |
| | | | irregular graphics. |
| | Geometric regular | Gridding, | Using regular geometric |
| | filling | rasterization, | units (such as triangles, |
| | | and reticulation | squares, rectangles, |
| | | | hexagons, circles, etc.) |
| | | | to fill irregular spatial |
| | | | areas. |
| Exaggeration | Geometric | Highlighting of key | The key units are |
| | reconstructing | units | processed in size, such |
| | | | as stretch 2 times in |
| | | | proportion, to prevent |
| | | | important information |
| | | | from being covered or |
| | | | highlighted, vice versa. |
| | Position resetting | Explicitly | According to the needs |
| | | expressing | of visual perception and |
| | | important icons | expression, resetting |
| | | | the position of the |
| | | | spatial object to |
| | | | transmit information |
| | | | rapidly. |
| Dimension | Object dimension | Geometric | Spatial object |
| transforming | reducing | dimension reducing | expression from 3D to |
| | | and position | 2D, and 2D to 1D |
| | | remapping | |
| | Object dimension | Geometric | Spatial object |
| | increasing | dimension | expression from 1D to |
| | | increasing and | 2D, and 2D to 3D |
| | | position remapping | |
| Element | Object | Point aggregating, | Point aggregating: use |
| aggregation | aggregating | edge bundling, face | numbers or colors to |
| | | integrating, and | represent the number of |
| | | volume merging | points. |
| | | | Edge bundling: use the |
| | | | thickness and color of |
| | | | edges to reflect the |
| | | | aggregation of edges. |
| | | | Surface integrating: the |
| | | | contour of the surface |
| | | | indicates the scope, and |
| | | | the color and texture |
| | | | indicate the type. |
| | | | Volume merging: Use |
| | | | complexes to represent |
| | | | the overall 3D space. |
| Element | Object dispersing | Point dispersing, | Point dispersing: using |
| divergence | | line segmenting, | detailed points to |
| | | surface divergence, | represent the |
| | | and volume | distribution. |
| | | segmenting | Line segmenting: using |
| | | | detailed edges to |
| | | | represent the line |
| | | | distribution. |
| | | | Surface divergence: |
| | | | using detailed surfaces |
| | | | to represent the spatial |
| | | | object distribution. |
| | | | Volume segmenting: |
| | | | using microscopic |
| | | | volume elements to |
| | | | represent the element |
| | | | distribution. |
| Metaphor | Spatializing | Metaphorically | Spatializing the non- |
| | expression | spatializing the | spatial elements by |
| | | non-spatial | constructing a virtual |
| | | elements | space. |
| Dynamicization | Dynamicization | Realizing dynamic | Linear time: |
| | expression | and continuous | transitioning |
| | | presentation | continuously. |
| | | according to the | Branch time: branching |
| | | time process | choosing |
| | | | Loop time: cyclic |
| | | | repetition |
| Tagging | Tagging | Replacing the tag | Replacing symbols |
| | expression | | with simple labels or |
| | | | word clouds. |
| Curling | Upward curling | Deformation of | The spatial reference |
| | | spatial reference | surface curls upward, |
| | | plane | showing convex |
| | | | deformation. |
| | Downward curling | Deformation of | The spatial reference |
| | | spatial reference | surface curls |
| | | plane | downward, showing |
| | | | concave deformation. |
| Multi-scale | Multi-scale | Spatial multi-scale | Multi-scale is to present |
| | | expression | different map forms by |
| | | | using different scales to |
| | | | achieve continuous |
| | | | transition expression of |
| | | | spatial objects |
| Stylization | Stylization | Cartoon style, oil | Line contour, color, and |
| | | painting style, stick | virtuality and reality |
| | | figure style | |
| Texturing | Texture | Summarizing and | LOD texture |
| | summarization | simplifying the | summarization |
| | | texture details | |
| Geometric | Geometric | Abstracting and | LOD Geometric |
| simplification | summarization | simplifying the | summarization |
| | | symbol outlines | |

Further, in an implementation of the embodiment, the step S220 includes the following steps:

Step S221, the regularization in the continuous transformation rules of the pan-map includes: one or a combination of structural relationship mapping, geometric substituting, and geometric regular filling; the step of constructing continuous transformation rules of the pan-map includes: transforming positions of spatial objects and keeping topological relationships of the spatial objects unchanged to achieve the structural relationship mapping; replacing irregular graphics with regular symbol units to achieve the geometric substituting; filling the irregular graphics with the regular symbol units to obtain gridded maps, rasterized maps, and textured maps, thereby realizing the geometric regular filling.

In the embodiment, the regularization refers to a specific structural processing of spatial objects during the map continuous transformation process, so as to achieve a more orderly and standardized state in visual expression, while ensuring that the topological relationship between spatial objects is preserved. The regularization includes: structural relationship mapping, geometric substituting, and geometric regular filling.

The structural relationship mapping: the arbitrary positional transformation of spatial objects, such as changing curvature or direction of lines, but in the process, ensure that the relative positional relationship and connectivity between objects remain unchanged, that is, the topological structure remains consistent. For example, a flow direction of a river can be simplified to a straight line. Although the shape changes, a connection relationship between upstream and downstream is still clearly discernible.

The geometric substituting: using standard geometric units (such as triangles, squares, rectangles, hexagons, circles, etc.) to replace the original complex irregular graphics, making map elements unified and regular. Especially when there is a large amount of information, it helps to quickly identify and compare.

The geometric regular filling: using regular geometric units to fill irregular spatial areas through gridding, rasterization, and reticulation to achieve a homogenized expression of space. This method has outstanding advantages in representing population density, land use type and other fields, and can clearly show the spatial distribution pattern.

In the embodiment, a purpose of the regularization is to reduce visual complexity, improve information readability and transmission efficiency, and maintain the accuracy and integrity of spatial information. The regularization plays a basic role in the continuous transformation of the pan-map, providing an orderly basic framework for subsequent continuous transformations. For example, other transformation rules such as exaggeration and the dimension transforming are further operated and deepened on the basis of regularization.

Step S222, the exaggeration in the continuous transformation rules of the pan-map includes: the geometric reconstructing and the position resetting; the step of constructing continuous transformation rules of the pan-map further includes: highlighting the key units to achieve the geometric reconstructing; and resetting the positions of spatial objects by explicitly expressing important icons to achieve the position resetting.

In the embodiment, the exaggeration in the continuous transformation rules of the pan-map refers to visually emphasizing and magnifying specific elements to highlight importance or simplify other elements, so as to achieve the purpose of quickly conveying core information and enhancing visual impact. The exaggeration includes: the geometric reconstructing and the position resetting.

The geometric reconstructing: the key units on the map are processed in size, such as enlarging the proportionally, or even exceeding the actual size, to prevent important information from being covered or highlighted. For example, the symbols of important cities or regions can be enlarged, bold, or used in eye-catching colors.

The position resetting: according to the needs of visual perception and information expression, the position of important map examples is adjusted to make them more prominent. For example, important landmarks can be moved to the center or edge of the map. Although the actual geographical location may deviate, it can convey information more quickly visually.

In the embodiment, a purpose of exaggeration is to quickly attract the viewer's attention and make the key information on the map immediately visible. By visually changing the size and position, the efficiency of information transmission is improved. Especially in information-intensive maps, exaggeration helps to distinguish the key points. The exaggeration does not destroy the overall coherence of the map, but emphasizes the continuity of information because the importance is clarified. Even if other information is simplified, it will not be distorted, and the overall continuous expression is still clear.

Step S223, the dimension transforming in the continuous transformation rules of the pan-map includes: object dimension reducing and object dimension increasing; the step of constructing of continuous transformation rules of the pan-map further includes: simplifying, by geometric dimension reducing and position remapping, high-dimensional space objects into low-dimensional space expressions to achieve the object dimension reducing; increasing, by geometric dimension increasing and the position remapping, low-dimensional spatial information to higher-dimensional expressions to achieve the object dimension increasing.

In the embodiment, the dimension transforming refers to the change of the map expression form in the spatial dimension in the continuous transformation rules of the pan-map, through geometric operations, from high dimension to low dimension or from low dimension to high dimension, so as to adaptively display information. Dimension transformation includes two key processes: the object dimension reducing and the object dimension increasing.

The object dimension reducing: simplify high-dimensional spatial objects into low-dimensional spatial expressions. For example, reduce a 3D terrain model to a 2D contour map, or simplify a complex 2D point distribution map to a 1D chart (such as population migration data displayed on a timeline). When reducing dimensions, the key is to retain the core features and important relationships of the original spatial objects, but simplify the expression form. dimension reduction can remove redundant information, make the core information more prominent, and facilitate understanding and dissemination.

The object dimension increasing: in contrast to dimension reduction, object dimension increase is to increase the low-dimensional spatial information to a higher dimension for expression, in order to provide a richer visual experience or reveal hidden structures. For example, 2D flat map data is increased to a 3D model to provide a more intuitive topographic experience, or linear time series data is presented through 3D animation to show the spatial evolution process over time. Dimensional increase can enhance the experience, provide more comprehensive information and more intuitive display of spatial sense, which is conducive to the understanding of complex relationships.

In the embodiment, a purpose of the dimension transforming is to adjust the map dimensions according to information display requirements, simplify complex information or enhance the intuitiveness of information, and adapt to different scenarios while maintaining information continuity. Through dimension adjustment, the map information expression is more in line with user needs, more adaptable, and improves information understanding efficiency. Whether it is dimension reduction or dimension increase, the continuity of the map is retained and the transmission of information is guaranteed.

Step S224, the element aggregation in the continuous transformation rules of the pan-map includes: point aggregating, edge bundling, face integrating, and volume merging; the step of constructing continuous transformation rules of the pan-map further includes: realizing the point aggregation by using numbers or colors to represent the number of aggregation points; realizing the edge bundling by using the thickness and color of the edge to represent the number of aggregation edges; realizing the face integration by using the outline of the face and the color texture to represent the type; realizing the volume merging by using a complex body to represent the overall 3D space.

In the embodiment, the element aggregation refers to combining scattered elements or data points, lines, surfaces, and volumes in the continuous transformation rules of the pan-maps to simplify or centralize processing, so as to achieve the purpose of information integration and clear expression. Element aggregation includes: point aggregating, edge bundling, surface integrating, and volume merging.

The point aggregating: use numbers or colors to represent the number of points and simplify the points in the point cluster. On the map, a large number of data points are represented as an area. For example, in a population distribution map, the high point area uses a gradient color block from light to dark to express the change in the number of points, simplifying while ensuring clear information.

The edge bundling: use the thickness and color of edges to reflect the aggregation of edges. For example, the thickness or color of traffic flow lines represents traffic flow; in road maps, multiple lines are simplified into thick lines, or the traffic volume is intuitively displayed through color depth to reduce visual burden.

The surface integrating: the contour of the surface indicates the scope, and the color and texture indicate the type. For example, in a regional land use map, different uses are indicated by different colors, and the type is expressed by texture, making the overall information clear.

The volume merging: Use complexes to represent the overall 3D space and display the distribution of elements. For example, in 3D city modeling, multiple buildings are merged into a building complex, and different colors are used to represent different functional areas.

In the embodiment, a purpose of element aggregation is to simplify map information, make important information more prominent, and make the information clear at a glance. By simplifying the expression through quantity, color, width, texture, comprehensive outline, overall shape, etc., the map information is made more intuitive and more adaptable, and the efficiency of information transmission is improved while maintaining continuity.

Step S225, the element divergence in the continuous transformation rules of the pan-map includes: point dispersing, line segmenting, surface divergence, and volume segmenting; the step of constructing continuous transformation rules of the pan-map also includes: realizing the point aggregation by using detailed points to represent the distribution; realizing the edge bundling by using detailed lines to represent the line distribution; realizing the surface integration by using detailed surfaces to represent the spatial object distribution; realizing the volume merging by using microscopic volume elements to represent the element distribution.

In the embodiment, the element divergence is one of the continuous transformation rules of the pan-map. In contrast to aggregating, it refers to decomposing aggregated elements to show more details, increase the fineness of the map and the accuracy of information, so as to more thoroughly describe the specific distribution of spatial objects. The element divergence includes: point dispersing, line segmenting, surface divergence, and volume segmenting.

The point dispersing: decompose the aggregated points into individual points to show the distribution details. Each point can represent an independent object. For example, a population density map can show the location and distribution pattern of the population in a more specific way through point dispersion.

The line segmenting: wide lines can be split into thin lines to show the details of the lines. For example, in a traffic map, wide lines can be split to show the divisions of each road, making the details clear.

The surface divergence: by face splitting, the comprehensive face is split into individual faces to show more detailed classification. For example, the regional map can decompose the land use of the city into different areas such as residential areas, commercial areas, and industrial areas, thus improving the information carrying capacity of the map.

The volume segmenting: the complex is broken down into microscopic volumes to show details. For example, a city model is decomposed into smaller parts or components to highlight specific structures and functions.

In the embodiment, a purpose of element divergence is to increase the information density of the map, improve accuracy, display detail, make the map suitable for scenes that require detailed expression, and make the information more specific and detailed through the detailed display of points, lines, surfaces and solids.

Step S226, the step of the constructing continuous transformation rules of the pan-map further includes: spatializing the non-spatial elements by constructing a virtual space to achieve the metaphor.

In the embodiment, the metaphor in the continuous transformation of the pan-map refers to mapping the abstract concepts and information of non-direct space to the geographic space by creating virtual space expression so that users can understand the intuitively. The metaphor uses spatial expression methods to make non-geographic information concrete, which is convenient for users to recognize.

Step S227, the dynamicization in the continuous transformation rules of the pan-maps includes: linear time, branch time, and loop time; the step of constructing continuous transformation rules of the pan-map further includes: presenting information changes through continuous expression of the time process to achieve the dynamicization.

In the embodiment, the dynamicization refers to realizing dynamic and continuous presentation of map content according to the time process to adapt to the changes of spatial objects in different time sequences. The dynamicization expression can be divided into three main forms: the linear time, the branch time, and the loop time.

The linear time: the map content transitions linearly over time, showing the direct evolution of spatial objects over time. It is suitable for showing continuous time series changes, such as seasonal changes, climate changes, etc.

The branching time: allows different development paths to be chosen in a time series, suitable for presenting situations with multiple possible outcomes or options, such as city development forecasts based on different directions of user decisions or historical events.

The loop time: the map content repeats itself in a specific cycle, emphasizing the cyclical pattern in time. It is suitable for showing cyclical phenomena such as seasonal cycles and economic cycles.

In the embodiment, the dynamicization expression can help users intuitively understand the evolution of spatial phenomena over time and enhance space-time cognition, which is particularly suitable for scenes that require dynamic process analysis, time series comparison, and predictive display. The dynamicization map expression method can better meet users' needs for real-time information, historical trends, and future predictions, and promote the efficient integration and dissemination of multiple information.

Step S228, the step of constructing the continuous transformation rules of the pan-map further includes: using labels or word clouds to replace symbols to achieve the tagging.

In the embodiment, the tagging refers to replacing traditional map symbols or complex visual elements with simple labels or word clouds to represent information. Through tagging, the map not only maintains the efficiency of instant information transmission, but also improves the aesthetic value of the map and the user's cognitive experience. In particular, in scenarios where there is a large amount of information and the key points need to be quickly grasped, the advantages of labeled maps are particularly significant.

Step S229, the curling in the continuous transformation rules of the pan-map includes: upward curling and downward curling; the step of constructing the continuous transformation rules of the pan-map further includes: curling upward through the spatial reference plane to present a convex deformation to achieve the upward curling; curling downward through the spatial reference plane to present a concave deformation to achieve the downward curling.

In the embodiment, the curling is a deformation process of the spatial reference surface of the map. The curling is divided into two forms: upward curling and downward curling, both of which are intended to provide a new visual expression method by changing the form of the spatial reference surface, thereby enhancing the expressiveness and information transmission effect of the map.

The upward curling: the spatial reference surface curls upward, showing convex deformation, just like the map surface is stretched. The processing can simulate the effects of terrain uplift and increased altitude, allowing users to obtain a 3D visual experience, which is conducive to expressing the undulations of terrain such as mountains and plateaus.

The downward curling: the spatial reference surface curls downward, showing concave deformation, similar to the compression of the map surface. It can be used to express terrain features such as low-lying areas and valleys, or to create a unique visual perspective effect, increasing the artistry and expressiveness of the map.

In the embodiment, curling provides users with a novel perspective and spatial cognition path by changing the spatial structure of the map, especially for the expression of natural geographical features such as terrain and landforms, which can enhance their 3D sense and sense of reality. The transformation not only enriches the expression means of the pan-map, but also makes the continuous transformation of the map more flexible and diverse, adapting to different scenes and information expression needs, and enhancing the application value of the pan-map in the era of information and communication technology.

Step S2210, the step of constructing continuous transformation rules of the pan-map, further includes: realizing the multi-scale through continuous expression of different scales.

In the embodiment, the multi-scale is to present different map forms by using different scales to achieve continuous transition expression of spatial objects. Through multi-scale transformation, the pan-map can display geographic spatial information, topological information, relationship information, statistical information, etc. at different spatial scales, so that users can form a comprehensive understanding of the change process of spatial objects from different perspectives and levels, thereby improving the understanding and analysis of complex geographical phenomena. The method is of great value in coping with the deep mining of spatial information, multi-angle analysis and cross-scale information integration in the ICT era.

Step S2211, changing the map style by changing the line outline, color, and virtuality and reality, so as to achieve stylization in the continuous transformation rules of the pan-map.

In the embodiment, the stylization is to change the map style by changing visual elements such as lines, colors, virtuality and reality, giving the map a different appearance and artistic effect. The stylization processing can include cartoon style, oil painting style, stick figure style, etc. By adjusting the line contour, color, and virtuality and reality, the map can maintain the original information transmission function while also having aesthetic value and emotional expression.

The cartoon style: map elements are presented in the form of cartoons or comics, which are simplified and exaggerated to make the map look more lively and friendly, suitable for map applications for children's education or relaxing themes.

The oil painting style: imitating the texture of oil painting, creating an artistic atmosphere through the thickness of colors and brushstroke effects, suitable for cultural and tourist maps, which can increase the ornamental and collection value.

The stick figure style: using simple lines and a small amount of color to outline map elements, emphasizing clarity and simplicity. It is suitable for quickly conveying information and is suitable for minimalist map design.

In the embodiment, the stylization processing not only enrich the visual expression of the map, but also enable the map to better match the user's emotions, cultural background or subject content in different application scenarios, thereby enhancing the user's acceptance and memory points. The stylized transformation is an innovative way to express the continuity of the map, which helps to expand the boundaries of its artistic and emotional expression while maintaining the functionality of the map, and meet personalized and diversified needs.

Step S2212, the step of constructing continuous transformation rules of the pan-map further includes: presenting the map information by summarizing and simplifying the texture details to achieve the texturing.

In the embodiment, the texturing is to optimize visual expression by summarizing and simplifying the texture details on the map. The goal of the texturing is to balance the aesthetics and functionality of the map and ensure a good visual experience at different zoom levels. The process involves Level of Detail (LOD) texture summarization, which can automatically adjust the complexity and fineness of the texture according to the distance between the user and the map or the display requirements of the information. Further, when the user focuses on the macro view of the map, the texture details are reduced to ensure that the map is clear and readable; while when observing at a microscopic level, the texture details are increased to display richer information. For example: when making a topographic map, when viewing from a distance, only the approximate mountain and plain textures may be displayed, and when viewed from a close distance, the delicate differences such as soil, vegetation, and rock textures are gradually displayed. This dynamic adjustment not only ensures the beauty of the map, but also optimizes the efficiency of information transmission. It is one of the important technical means to achieve information association, integration, and transmission of multiple information in the continuous expression-transformation of the pan-map.

Step S2213, the step of constructing continuous transformation rules of the pan-map also includes: simplifying a symbol outline through geometric generalization to achieve the geometric simplification.

In the embodiment, the geometric simplification refers to abstracting and simplifying the symbol outlines in the map to reduce complexity and improve readability and loading efficiency of the map. The process usually uses LOD geometric generalization, that is, dynamically adjusting the geometric complexity of map elements according to the user's viewing angle and needs of the map. The purpose of geometric simplification is to improve performance and user experience of the map without sacrificing the accuracy of map information transmission, especially in web map applications, mobile devices or resource-constrained environments. Through the geometric simplification, the continuous transformation of the pan-map can adapt to different conditions and user needs more smoothly, improving the practicality and interactivity of the map.

As shown in FIG. 1, in an implementation of the embodiment of the present disclosure, the method for continuous expression-transformation of pan-maps based on continuity features further includes the following steps:
Step S300, performing, based on the continuous transformation rules of the pan-map, continuous expression-transformation processing on a plurality of pan-map types, and outputting continuous expression-transformation results of the plurality of pan-map types.

In the embodiment, based on the continuous transformation rules of the pan-map, the continuous transformation of map space, map base, spatial position, spatial relationship, and map symbols is realized through the morphing algorithm. On a basis of clarifying the transformation rules and algorithms, the continuous transformation of map elements is realized through mathematical formulas, geometric operations, and graphics processing technology. For example, remapping of spatial positions, dynamic adjustment of symbols, continuous transition of spatial relationships, etc., ensure that the geographic information of the map remains accurate and visually smooth during the transformation process.

Further, in an implementation of the embodiment, the step S300 includes the following steps:
Step S310, performing, based on the continuous transformation rules of the pan-map, the continuous expression-transformation processing on the plurality of pan-map types by a progressive transformation algorithm;
Step S320, outputting the continuous expression-transformation results of the plurality of the pan-map types.

In the embodiment, based on the continuous transformation rules of the pan-map, the continuous transformation of the map space, the map base, the spatial position, the spatial relationship, and the map symbols is realized through the morphing algorithm. For example: in a transformation of the population migration map to the Kriskogram map, the map space is changed from 2D to 1D, the topological relationship of the spatial objects is retained, and the spatial position of the map elements is remapped, so that the original plane spatial base becomes a straight line. In a transformation of the subway line map to the schematic subway map, the spatial relationship changes from Euclidean distance to topological relationship, the shape, distance, direction and color of the symbols have changed, and the position has undergone regularization, and the direction has changed from disorder to being restricted by eight directions such as east, west, south, north and 45 degrees. In a transformation of the classification statistical map to the Dorling Cartogram map, the spatial relationship and the shape of the symbol also undergo the same changes, realizing the geometric substitution of the spatial position.

In the embodiment, through the above process, the morphing algorithm not only changes the spatial structure and visual expression of the map, but also maintains the logical relationship between map elements, so that users can understand the change process of spatial information from multiple dimensions and levels, and enhance the dynamic cognition of spatial objects. The transformation method provides strong technical support for the association, integration and transmission of map information, and adapts to the higher requirements for map expression in the information and communication technology era.

Further, a population migration map to a Kriskogram map and a classification statistical map to a Dorling Cartogram map are taken as examples to test the continuous morphing transformation method of the pan-map.

1. Continuous morphing transformation of a point map: taking the population migration map and the Kriskogram map as examples.

From the population migration map and the Kriskogram map, a coordinate mapping relationship between location points is established to achieve dimension reduction from 2D to 1D. The migration flow represents a semicircle drawn in a clockwise direction from the starting point to the end point, with a center of the circle located at the midpoint between the two corresponding points on a positioning line. On the horizontal positioning line, if the origin is on the left side of the destination, a semicircle is drawn on the line, otherwise a semicircle is drawn below the line.

The specific method is as follows:

(1) Determining coordinates of mapping points: using an average latitude of all migration points as the y value of the mapping points. The x value is the value assigned to the original point from 0 to the given number of steps from east to west.

(2) Drawing points in a loop: For each loop, interpolation is performed according to the number of steps, and the position of the point is gradually moved. The specific calculation formula is as follows:

$${y}_{1} = {y}_{fr} - p \times ( {y}_{fr} - {y}_{ave} ) ;$$

$${y}_{2} = {y}_{to} - p \times ( {y}_{to} - {y}_{ave} ) ;$$

$${x}_{1} = ( 1 - p ) \times {x}_{fr} + p \times {x}_{p} ;$$

$${x}_{2} = ( 1 - p ) \times {x}_{to} + p \times {x}_{p} ;$$

where y_{fr} is the latitude of the starting point of population migration; yₜₒ is the latitude of the end point of population migration; x_{fr} is the longitude of the starting point; xₜₒ is the longitude of the end point; yₐᵥₑ is the average latitude value of the original data; p is the progress of the loop with a value between 0 and 1; the longitudes of the points are sorted from east to west and assigned x values in turn. The x values of the points differ by a constant value in turn, is the xₚ value of the projection coordinates.

(3) Drawing lines in a loop: For each step, loop through the data and draw an arc between each pair of start and end points.

2. Performing continuous transformation on surface maps: taking the classification statistical maps and the Dorling maps as examples.

The process of generating a new polygon based on the intersection point, reference circle information (center and radius), and deformation ratio. The distance from each intersection point to the center of the circle is calculated, and then the distances are adjusted according to the deformation ratio to obtain the new project point position, and finally these vertices are used to define a new polygon.

The specific method is as follows:

(1) Using a loop from 0 to 1 with a step size of 0.02, using i to record the value, and for each i value in each loop, using i*i (accurate to 4 decimal places) to represent the deformation ratio to gradually change the shape of the polygon.

(2) Traversing all polygons.

(3) For each polygon, determining an internal reference point and reference circle radius.

(4) Calculating the maximum width and height of the polygon, and using the maximum value of the width and height as the length of the ray.

(5) Generating 360 rays from the reference point outward and calculating the intersection of the rays with the polygon boundary. If it is a single point, adding the point directly to the list. If it is multiple points, traversing all points and adding each point to the list; Generating a new polygon by using the intersection and reference circle information and deformation ratio. For each intersection point, first calculating the distance d_{c} to the center of the circle, and combining the distance with the deformation ratio to calculate the new distance d_{new}:

$${d}_{new} = {d}_{c} \times ( 1 - p ) + r \times p ;$$

where p is the deformation ratio and r is the circle radius.

The embodiment achieves the following technical effects through the above technical solutions:

In the embodiment, a plurality of map types can be obtained by obtaining pan-map type cases, and classifying and categorizing the pan-map type cases, thus a pan-map classification system can be constructed; continuous transformation association information between the plurality of map types can be extracted according to the pan-map classification system, and constructing continuous transformation rules of the pan-map can be constructed; based on the continuous transformation association information of the pan-map, continuous expression-transformation of the plurality of pan-map types can be realized, thus improving the information carrying capacity of maps and providing support for the association, integration and transmission of multiple information in the ICT era. The present disclosure provides a new method for continuous expression-transformation of pan-maps based on continuity features, and on a basis of collecting more than 1000 cases of map visualization types, the pan-map classification system is constructed, and 13 rule sets of continuous expression of the pan-map are clearly defined. Based on the rule sets of continuous expression of the pan-map, a continuous transformation method of pan-map is proposed, which can dynamically and intuitively display geographical spatial information, topological information, relational information, and statistical information of spatial objects from multiple angles, multiple levels and all directions, so that users can form a continuous and dynamic process mental image of spatial objects and enhance people's understanding of the changing process of spatial objects.

### A Device Embodiment

Based on the above embodiments, the present disclosure also provides a terminal, including: a processor, a memory, an interface, a display screen, and a communication module connected via a system bus; where the processor is used to provide computing and control capabilities; the memory includes a storage medium and an internal memory; the storage medium stores an operating system and a computer program; the internal memory provides an environment for the operation of the operating system and the computer program in the storage medium; the interface is used to connect external devices, such as mobile terminals and computers; the display screen is used to display corresponding information; and the communication module is used to communicate with a cloud server or a mobile terminal.

When the computer program is executed by the processor and is used to implement the operation of a method for continuous expression-transformation of pan-maps based on continuity features.

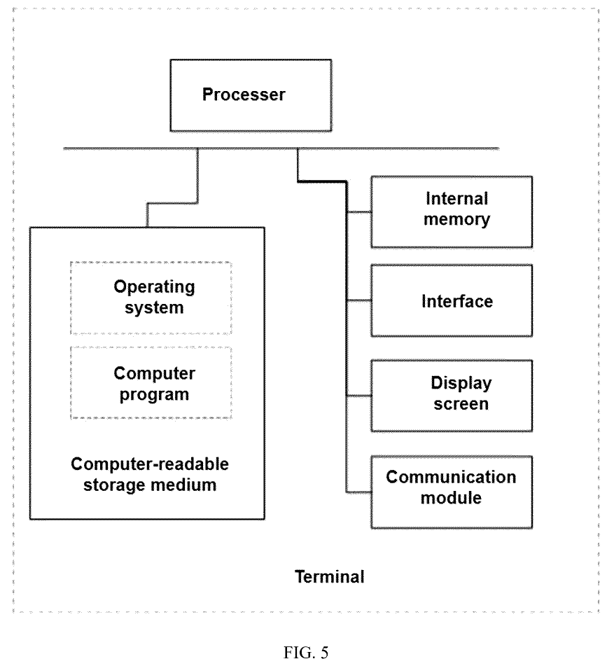

Those skilled in the art can understand that the principle block diagram shown in FIG. 5 is only a functional schematic diagram of a partial structure related to the scheme of the present disclosure, and does not constitute a limitation on the terminal to which the scheme of the present disclosure is applied. The specific terminal may include more or fewer components than those shown in the drawings, or combine certain components, or have a different arrangement of components.

In one embodiment, a terminal is provided, including: a processor and a memory, where the memory stores a program of continuous expression-transformation of pan-maps based on continuity features, which is used to implement the operation of the method for continuous expression-transformation of pan-maps based on continuity features as described above when executed by the processor.

In one embodiment, a computer-readable storage medium is provided, which stores the program of continuous expression-transformation of pan-maps based on continuity features, and the program of continuous expression-transformation of pan-maps based on continuity features is used to implement the operation of the method for continuous expression-transformation of pan-maps based on continuity features as described above when executed by the processor.

Those skilled in the art can understand that all or part of the processes in the above-mentioned embodiments can be implemented by instructing related hardware through a computer program, and the computer program can be stored in a non-volatile storage medium. When the computer program is executed, it can include the processes of the embodiments of the above-mentioned methods. Among them, any reference to memory, storage, database or other media used in the embodiments provided by the present disclosure can include non-volatile and/or volatile memory.

In summary, the present disclosure provides a method and a terminal for continuous expression-transformation of pan-maps based on continuity features, the method includes: obtaining pan-map type cases, classifying and categorizing the pan-map type cases to obtain a plurality of map types, and constructing a pan-map classification system; extracting continuous transformation association information between the plurality of map types according to the pan-map classification system, and constructing continuous transformation rules of the pan-map; performing, based on the continuous transformation rules of the pan-map, continuous expression-transformation processing on a plurality of pan-map types, and outputting continuous expression-transformation results of the plurality of pan-map types. The method for continuous expression-transformation of pan-maps based on continuity features can enhance the information richness and continuity of the map, and improve efficiency of information association, integration and transmission.

It should be understood that the use of the present disclosure is not limited to the above embodiments. For those skilled in the art, improvements or changes can be made based on the above description. All these improvements and changes should fall within the scope of protection of the claims attached to the present disclosure.

What is claimed is:

1. A method for continuous expression-transformation of pan-maps based on continuity features, the method comprising:
obtaining pan-map type cases, classifying and categorizing the pan-map type cases to obtain a plurality of map types, and constructing a pan-map classification system;
extracting continuous transformation association information between the plurality of map types according to the pan-map classification system, and constructing continuous transformation rules of the pan-map; and
performing, based on the continuous transformation rules of the pan-map, continuous expression-transformation processing on a plurality of pan-map types, and outputting continuous expression-transformation results of the plurality of pan-map types.

2. The method for continuous expression-transformation of pan-maps based on continuity features according to claim 1, wherein obtaining pan-map type cases, classifying and categorizing the pan-map type cases to obtain a plurality of map types, and constructing the pan-map classification system comprises:
obtaining a plurality of map type cases, and classify the plurality of map type cases from perspectives of point maps, line maps, surface maps, and volume maps to obtain the plurality of map types; and
constructing the pan-map classification system based on classification results.

3. The method for continuous expression-transformation of pan-maps based on continuity features according to claim 2, wherein constructing the pan-map classification system based on classification results comprises:
displaying, based on the classification results of the map types, the map types of different levels and subcategories by a tree structure to form the pan-map classification system; and
placing, on a basis of the pan-map classification system, the each pan-map type case in a database of the corresponding type, and constructing a pan-map case library.

4. The method for continuous expression-transformation of pan-maps based on continuity features according to claim 1, wherein the continuous transformation rules of the pan-map comprise: one or a combination of regularization, exaggeration, dimension transforming, element aggregation, element divergence, metaphor, dynamicization, tagging, curling, multi-scale, stylization, texturing, and geometric simplification;
wherein the step of extracting continuous transformation association information between the plurality of map types according to the pan-map classification system, and constructing continuous transformation rules of the pan-map comprises:
extracting, based on the pan-map classification system, continuity association information of elements between the plurality of map types by an inductive method; and
summarizing and generalizing mechanism and logic of the continuity association information of the elements between the plurality of map types to construct the continuous transformation rules of the pan-map.

5. The method for continuous expression-transformation of pan-maps based on continuity features according to claim 4, wherein the regularization in the continuous transformation rules of the pan-map comprises: one or a combination of structural relationship mapping, geometric substituting, and geometric regular filling; and
constructing continuous transformation rules of the pan-map comprises:
transforming positions of spatial objects and keeping topological relationships of the spatial objects unchanged to achieve the structural relationship mapping;
replacing irregular graphics with regular symbol units to achieve the geometric substituting; and
filling the irregular graphics with the regular symbol units to obtain gridded maps, rasterized maps, and textured maps, thereby realizing the geometric regular filling.

6. The method for continuous expression-transformation of pan-maps based on continuity features according to claim 4, wherein the exaggeration in the continuous transformation rules of the pan-map comprises: geometric reconstructing and position resetting; and
constructing continuous transformation rules of the pan-map further comprises:
highlighting key units to achieve the geometric reconstructing; and
resetting positions of spatial objects by explicitly expressing important icons to achieve the position resetting.

7. The method for continuous expression-transformation of pan-maps based on continuity features according to claim 4, wherein the dimension transforming in the continuous transformation rules of the pan-map comprises: object dimension reducing and object dimension increasing; and
constructing continuous transformation rules of the pan-map further comprises:
simplifying, by geometric dimension reducing and position remapping, high-dimensional space objects into low-dimensional space expressions to achieve the object dimension reducing; and
increasing, by geometric dimension increasing and the position remapping, low-dimensional spatial information to higher-dimensional expressions to achieve the object dimension increasing.

8. The method for continuous expression-transformation of pan-maps based on continuity features according to claim 1, wherein performing, based on the continuous transformation rules of the pan-map, continuous expression-transformation processing on a plurality of pan-map types, and outputting continuous expression-transformation results of the plurality of pan-map types, comprises:
performing, based on the continuous transformation rules of the pan-map, the continuous expression-transformation processing on the plurality of pan-map types by a progressive transformation algorithm; and
outputting the continuous expression-transformation results of the plurality of pan-map types.

9. A terminal, comprising a processor and a memory, wherein the memory stores a program for continuous expression-transformation of pan-maps based on continuity features, and wherein the program for continuous expression-transformation of pan-maps based on continuity features is executed by the processor, the program is used to implement the method for continuous expression-transformation of pan-maps based on continuity features according to claim 1.

10. A non-transitory computer-readable storage medium, wherein the non-transitory computer-readable storage medium stores a program for continuous expression-transformation of pan-maps based on continuity features, and when the program for continuous expression-transformation of pan-maps based on continuity features is executed by a processor, the program is used to implement the method for continuous expression-transformation of pan-maps based on continuity features according to claim 1.
